(19) United States
(12) Patent Application Publication
(10) Pub. No.: US 2002/0087775 A1
(43) Pub. Date: Jul. 4, 2002

(54) APPARATUS AND METHOD FOR INTERRUPT DELIVERY

(76) Inventors: Lily P. Looi, Portland, OR (US); Manoj Khare, Saratoga, CA (US)

Correspondence Address: KENYON & KENYON, Suite 600, 333 W. San Carlos, Street, San Jose, CA, 95110-2711, US

(21) Appl. No.: 09/752,874

(22) Filed: Dec. 29, 2000

(51) Int. Cl. G06F 13/24

(52) U.S. Cl. 710/260

(57) ABSTRACT

An interrupt delivery system is provided for delivering interrupt requests in a multi-node computer system. The interrupt delivery system includes a pair of scaleable node controllers, each of which supports at least one microprocessor. The scaleable node controllers are coupled to a scalability port switch, which receives an interrupt request. The scalability port switch determines an address of one of the scaleable node controllers from the interrupt request. Based on the address, the scalability port switch then transmits the interrupt request to the correct scaleable node controller.

### BACKGROUND OF THE INVENTION

1. Field of the Invention

The present invention relates generally to delivering interrupt requests to microprocessors. More particularly, the present invention relates to delivering interrupt requests to a multiple processors in a system utilizing multi-node architecture.

2. Description of the Related Art

In a conventional computer system, an input device, such as a keyboard, a disk drive, a joystick, or a mouse generates an interrupt request when it is used. An interrupt request functions to stop or interrupt a microprocessor from the program it was executing and force the processor to pay attention to and service the input device. For example, if a user presses a key on a keyboard, the keyboard generates an interrupt request to interrupt the processor from the program it was executing. The processor will service the input from the keyboard before resuming the original program it was executing.

Depending on the purpose of the key press, the processor may detect what key was hit and display it on the screen. In another case, the processor may detect what key was hit to issue a command to the computer, such as a command in a video game or a command in the operating system. Clearly, during the normal operation of a computer, it is possible for an input device to generate a large number of interrupt requests. Further, each computer system may include multiple input devices. Therefore, to optimize system performance, it is important to deliver each of the interrupt requests to the correct processor in an efficient manner.

FIG. 1 illustrates a conventional interrupt delivery system 10 for a single-node computer system. Interrupt delivery system 10 includes a scalable node controller (SNC) 12, which is coupled to an input/output hub (IOH) 14 and a number of processors 16a-d. IOH 14 is coupled to a number of peripheral component interconnect (PCI) devices 18a-b. The design of interrupt delivery system 10 (such as the 460 GX system produced by Intel Corporation) was a major improvement over previous generations because it allows interrupt requests to be delivered virtually from PCI devices 18a-b to processors 16a-d. In a previous generation (such as the 450 NX system produced by Intel), an interrupt request generated by PCI devices would be delivered to processors through side wires (sometimes referred to as APIC sideband bus).

When a PCI device 18a or 18b requires servicing, it performs a write command to a special address. The write is received by IOH 14 and transmitted on the data bus to SNC 12. After receiving the write, SNC 12 recognizes the special address to be written to and converts the write command to an interrupt request. Each interrupt request includes an ID, which identifies the processor 16a, 16b, 16c, or 16d that should be interrupted by the request. If the specific processor is not too busy (i.e., executing a program with a higher priority), the processor is interrupted and services PCI device 18a or 18b before resuming the execution of the previous program. If the specific processor is too busy, SNC 12 may transmit the interrupt request to the processor when it has finished the more important task or if SNC 12 has the proper information, it may redirect the interrupt request to a different processor.

Recent developments in computer technology have allowed for the design and manufacture of computer systems implementing a multi-node architecture (i.e., multiple SNCs). Each additional node is able to support an additional set of processors that may operate simultaneously with all of the other processors, resulting in a tremendous increase in computing power. Furthermore, the additional nodes also provide the system with greater flexibility (in the event that a node fails) and additional memory. The end result is a multi-node computer system that offers a great deal more reliability, accessibility, and service (RAS) than a single-node system.

While interrupt delivery system 10 is adequate to support delivery of interrupt requests to a single node along a single, straight pathway, it does not provide any mechanism to deliver requests to multiple nodes along more complicated pathways. If, for example, an additional SNC were coupled to IOH 14, interrupt delivery system 10 would be unable to identify which SNC should receive an interrupt request. Therefore, it would be impossible route the interrupt request to the correct processor.

In addition, not being able to facilitate the simple delivery of interrupt requests from PCI devices to processors, interrupt delivery system 10 also does not provide mechanisms for redirecting interrupt requests to a processor located on a different node or for sending an interrupt request from a processor to another processor located on a different node. Therefore, it is desirable to have a method and apparatus for routing and delivering interrupt requests along the pathways of a multi-node system.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a conventional interrupt delivery system in a single-node computer system.

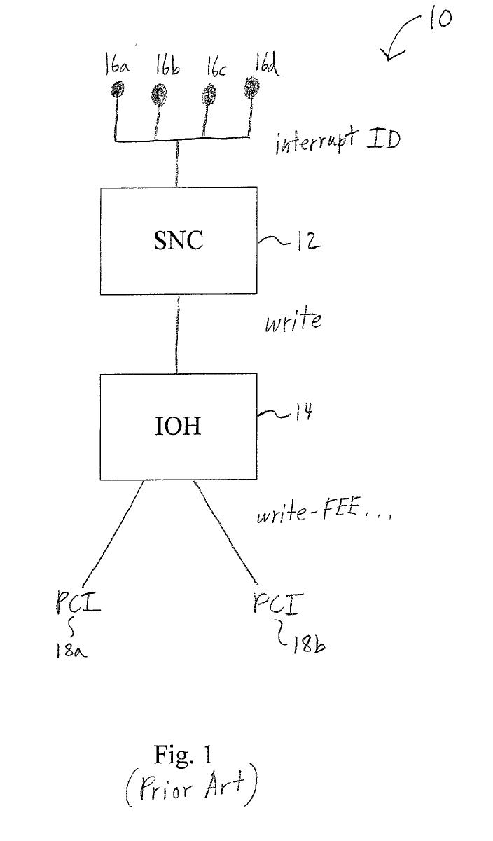

FIG. 2 illustrates an interrupt delivery system for a multi-node computer system in accordance with one embodiment of the present invention.

FIG. 3 illustrates an interrupt delivery system for a multi-node computer system in accordance with a preferred embodiment of the present invention.

FIG. 4 illustrates mechanisms of the interrupt delivery system for delivering interrupts in an IA32 system.

FIG. 5 is a flow chart of a method for delivering IRQs in a multi-node computer system in accordance with one embodiment of the present invention.

### DETAILED DESCRIPTION

A method and apparatus for routing and delivering interrupt requests in a multi-node system is provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

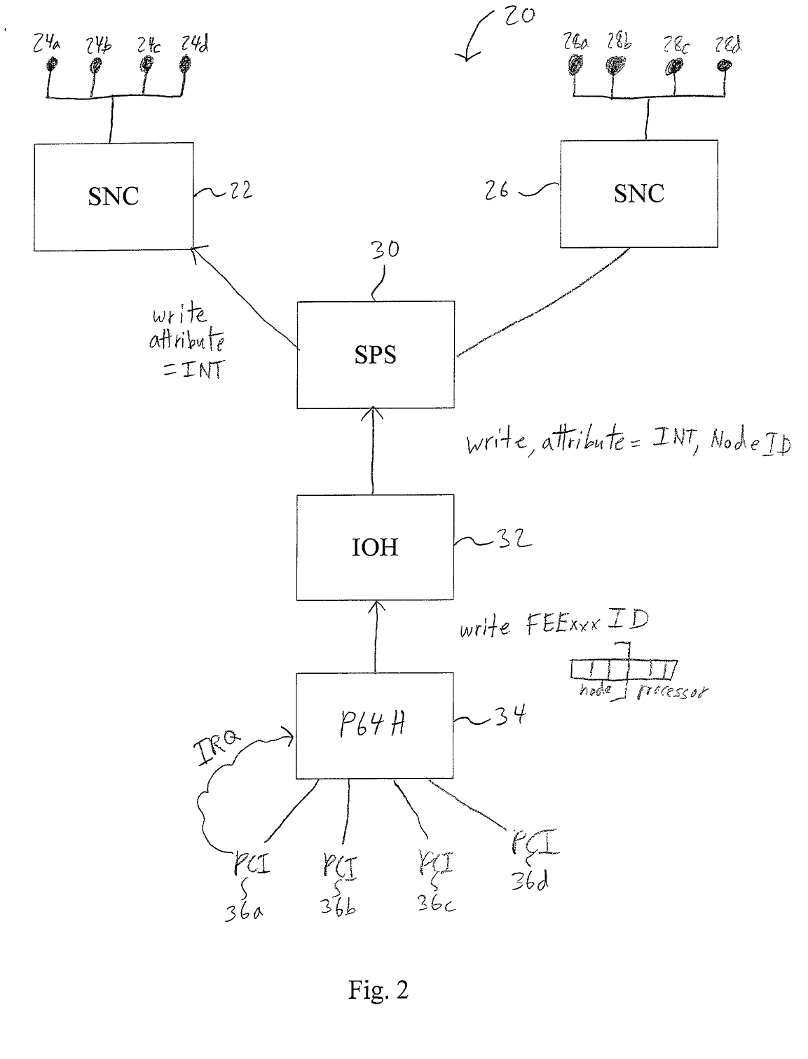

FIG. 2 illustrates an interrupt delivery system 20 for a multi-node computer system in accordance with one embodiment of the present invention. Interrupt delivery system 20 includes a first SNC 22, which is coupled to processors 24a-d, and a second SNC 26, which is coupled to processors 28a-d. Both SNCs 22 and 26 are coupled to a SPS 30, which is in turn coupled to an IOH 32. IOH 32 is also coupled to a PCI 64-bit hub (P64H) 34, which supports a number of PCI devices 36a-d.

If, for example, PCI device 36a requires servicing, it generates an interrupt request (IRQ), which is transmitted to P64H 34 through a side wire 37. After receiving the IRQ, an interrupt controller inside P64H 34 converts the IRQ into a write command and an ID 38 containing the destination information of the IRQ. ID 38 preferably includes a node address 40 and a processor address 42. The data is then transmitted to SPS 30 through IOH 32 (which will be detailed below) as a write command having an attribute equal to an interrupt and ID 38.

Based on the node ID, SPS 30 will transmit the write command and its attribute to the correct SNC. The SPS accomplishes this task because it contains registers that stores the ID of the SNCs. Assuming that SNC 22 is identified by node address 40, SNC 22 will read processor address 42 to determine the correct destination processor. SNC 22 then analyzes a register 44 with priority information about each processor 24a-d indicating whether or not it may be interrupted. Register 44 is located within SNC 22 itself and collects status reports from processors 24a-d. Assuming that processor 24a may be interrupted and is identified by processor address 42, SNC 22 will translate the write and attribute to a processor bus interrupt request that is sent to processor 24a. Processor 24a will then temporarily interrupt the program it is running to service PCI device 36a.

If processor 24a is too busy to accept the IRQ, SNC 22 may decide to either wait until the task with the higher priority is completed before sending the IRQ, or SNC 22 may choose to redirect the IRQ to another processor. (Note, the Intel 870 Chipset always redirects to the least busy processor instead of waiting.) To support the redirection process, ID 38 may include an indicator bit, which indicates whether the IRQ may be redirected. If the indicator bit confirms that IRQ may be redirected, then SNC 22 may redirect the IRQ to SNC 26, which performs the same analyses of the IRQ to determine which processor 28a-d may be interrupted.

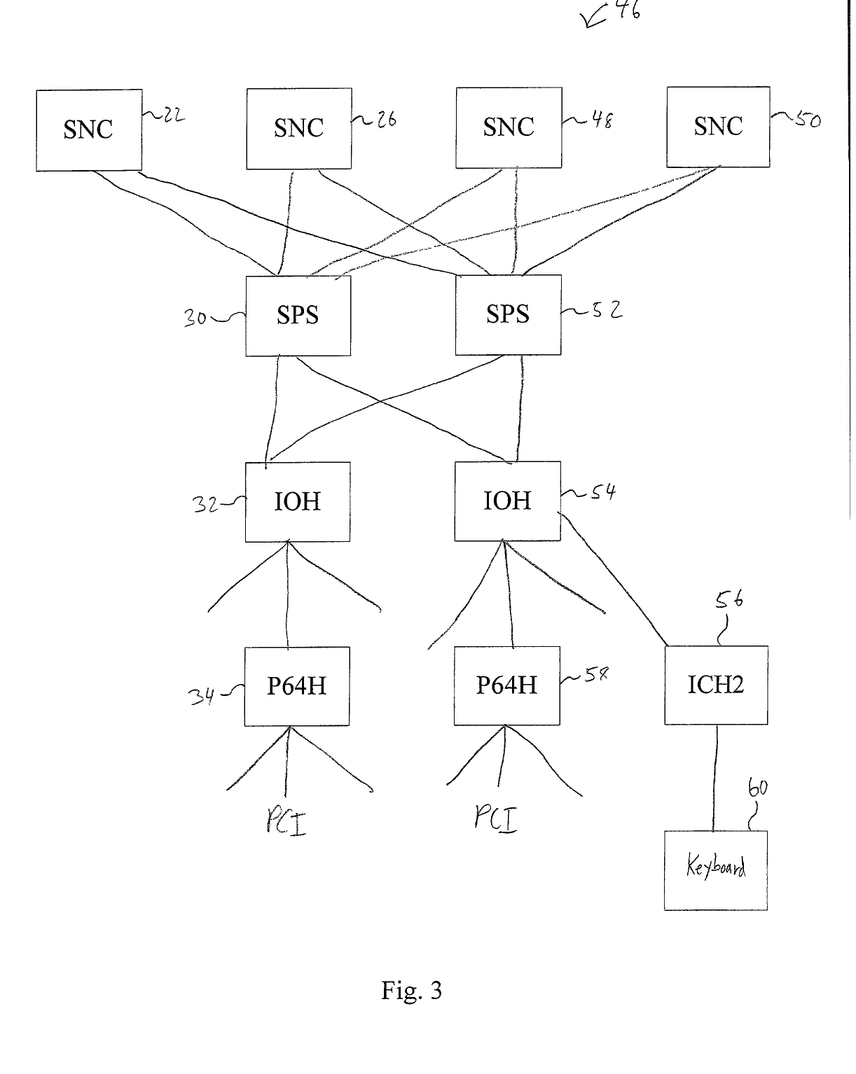

FIG. 3 illustrates an interrupt delivery system 46 for a multi-node computer system in accordance with a preferred embodiment of the present invention. The operation of interrupt delivery system 46 is similar to interrupt delivery system 20, described in FIG. 2. However, interrupt delivery system 46 is optimized to support two additional SNCs 48 and 50, for a total of four SNCs, each of which supports a set of processors. The end result is a multi-node system having a great deal of processing power (such as in the Intel 870 Chipset).

Each SNC 22, 26, 48, and 50 is coupled to SPSs 30 and 52. While an additional SPS is not necessary for interrupt delivery system 46 to operate, it provides for twice as much throughput and maximum bandwidth. The additional SPS also provides a backup, in case one SPS is disabled. SPSs 30 and 52 are then coupled to IOHs 32 and 54. The main purpose of using an IOH in interrupt delivery system 46 is for expandability. Each IOH is able to support numerous PCI hubs, including an interconnect hub (ICH2) 56 and P64Hs 34 and 58 as illustrated in FIG. 3. ICH2 56 is a type of PCI hub that is configured to support a keyboard 60. Each of the PCI devices shown in FIG. 3, including keyboard 60 represent a newer type of PCI device which is able to generate a write command, thereby eliminating the need for side wire connections to a PCI hub.

Each embodiment of the present invention may also be easily modified to include mechanisms to facilitate IRQ delivery in different multi-node systems. One such example of modified IRQ delivery is IRQ delivery to microprocessors from legacy devices such as an 8259 controller. With such devices, once the processor has received the IRQ, an interrupt acknowledge must be sent back to the interrupt controller to confirm receipt of the IRQ. Another example of a system for which the present invention may be modified is the IA32 system.

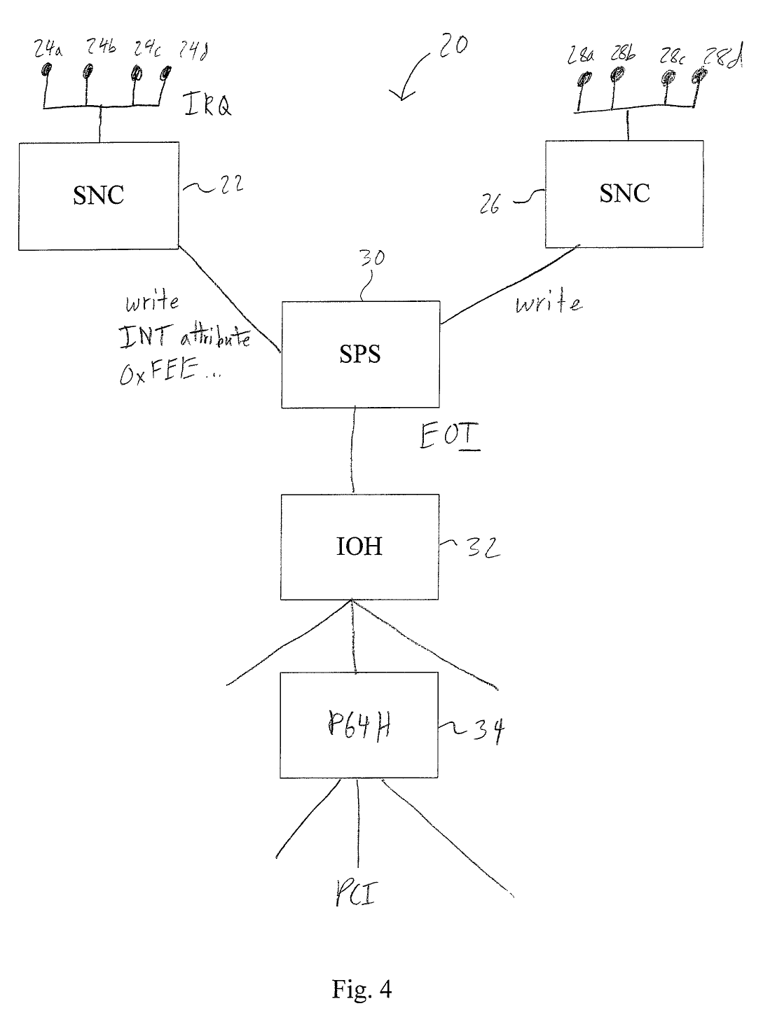

FIG. 4 illustrates mechanisms of interrupt delivery system 20 for delivering interrupts in an IA32 system (an example of which would be the Pentium 4 family). Because the identification scheme in IA32 systems is less efficient than in IA64 systems, the IA32 has two additional interrupt delivery requirements. First, after each level triggered interrupt delivery, SPS 30 (actually the whole chipset) is required to issue an end of interrupt (EOI) to communicate to the interrupt controller embedded in the P64H2 or ICH2 that the processor is finished servicing a particular PCI device.

Since the EOI message from the processor does not contain information as to which interrupt controller the interrupt came from, the chipset must devise a way to deliver the EOI to the correct interrupt controller. (Only the interrupt vector is available.) This is done by the SNC sending the EOI message to the SPS. The SPS broadcasts the EOI to all IOH components. Finally, the IOH broadcasts the EOI to all P64H2s and ICH2s. The interrupt controller that recognizes the interrupt vector will act on the EOI. Remaining controllers will ignore it.

Second, an IA32 system also needs to sometimes send a broadcast interrupt. A broadcast interrupt occurs when a processor (i.e., processor 24a) or I/O device sends an IRQ to all other processors in the system. For example, the broadcast IRQ is received by SNC 22 from the processor, which issues a write command with an interrupt attribute to SPS 30. SPS 30 is able to recognize the origin of the command and forward it to all of the other SNCs in the system, in this case SNC 26. One example of a broadcast interrupt is when a laptop computer powers back up from standby mode. In this example, the user hits the proper function buttons and a processor (or device) issues a broadcast interrupt to all other processors in the system to restart the system. In each case (legacy, EOI, and broadcast IRQs), the flexibility of the interrupt delivery systems of the present invention allows for painless adaptation to the interrupt delivery needs of other systems.

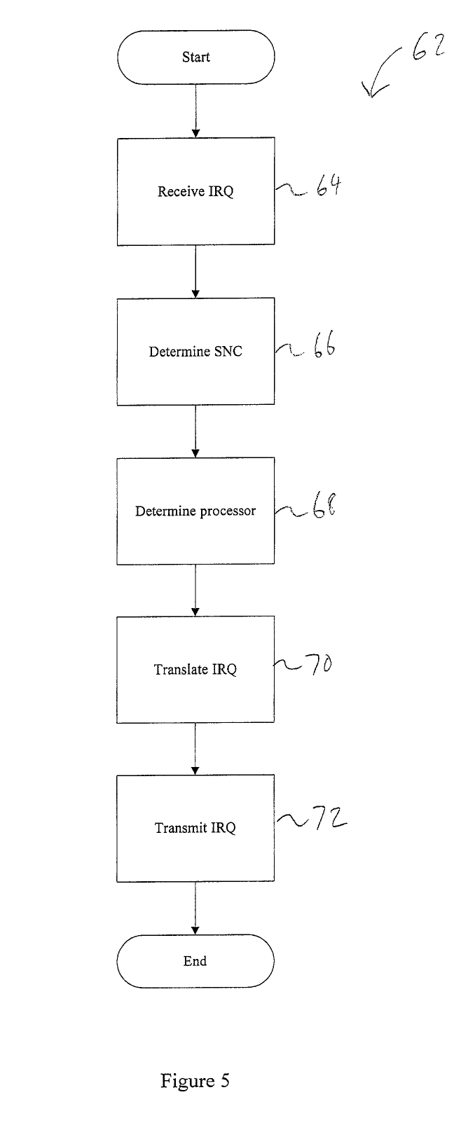

FIG. 5 is a flow chart of a method 62 for delivering IRQs in a multi-node computer system in accordance with one embodiment of the present invention. Method 62 begins at a block 64 where an interrupt request is received by a scalability port switch. The IRQ may be generated by either an input device or a processor. The input device is preferably a PCI device that can generate an in band IRQ (in the form of a write and attribute command) to the SPS through a PCI hub and an IOH. After receiving the request, the SPS determines a scaleable node controller to receive the interrupt request in a block 66. The write and attribute also includes an ID having a node address identifying the proper SNC for the SPS to transmit to.

Once the correct SNC has been identified, method 62 proceeds to a block 66 where the interrupt write and attribute is transmitted to the proper SNC. Upon receiving the IRQ, the SNC determines which processor to interrupt in a block 68. The identity of the processor may be determined from the processor address in the ID. Once the correct processor has been identified, the SNC preferably compares the priority of the IRQ with the priority of the current processor task. If the processor is too busy to interrupt, the SNC may decide to delay interrupting the processor until it is less busy, or to redirect the IRQ to a different processor on a different node through the SPS. Otherwise, in a block 70, the SNC translates the write and attribute commands to an IRQ that can be understood by the processor and then transmits the IRQ to the processor in a block 72.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

What is claimed is:

1. An interrupt delivery system, comprising:
a first pair of scaleable node controllers, wherein each of said scaleable node controllers supports at least one microprocessor;
a first scalability port switch coupled to each of said scaleable node controllers, wherein said first scalability port switch is to receive an interrupt request, determine an address of one of said scaleable node controllers from said interrupt request and transmit said interrupt request to said one of said scaleable node controllers.

2. An interrupt delivery system as recited in claim 1, further comprising a peripheral component interconnect device.

3. An interrupt delivery system as recited in claim 2, further comprising a peripheral component interconnect bus coupled between the peripheral component interconnect device and the first scalability port switch, wherein said peripheral component interconnect bus is able to support a plurality of additional peripheral component interconnect devices.

4. An interrupt delivery system as recited in claim 3, further comprising a first input/output hub coupled between the peripheral component interconnect bus and the first scalability port switch, wherein said first input/output hub is able to support a plurality of additional peripheral component interconnect hubs.

5. An interrupt delivery system as recited in claim 4, further comprising a second pair of scaleable node controllers, wherein said second pair of scaleable node controllers are coupled to said first scalability port switch.

6. An interrupt delivery system as recited in claim 5, wherein the first pair of scaleable node controllers and the second pair of scaleable node controllers are coupled to a second scalability port switch.

7. An interrupt delivery system as recited in claim 5, wherein the second scalability port switch is coupled to the first input/output hub.

8. An interrupt delivery system as recited in claim 7, wherein the second scalability port switch is coupled to a second input/output hub, wherein said second input/output hub is able to support a plurality of additional peripheral component interconnect hubs and wherein each of the scaleable node controllers is coupled to four microprocessors.

9. A method for delivering an interrupt request in a multi-node computer system, comprising:
receiving an interrupt request;
determining a scaleable node controller to receive said interrupt request; and
transmitting said interrupt request to said scaleable node controller.

10. A method for delivering an interrupt request in a multi-node computer system as recited in claim 9, further comprising determining a processor to receive the interrupt request.

11. A method for delivering an interrupt request in a multi-node computer system as recited in claim 10, further comprising comparing a priority of the IRQ with a priority of the processor.

12. A method for delivering an interrupt request in a multi-node computer system as recited in claim 11, further comprising interrupting the processor.

13. A method for delivering an interrupt request in a multi-node computer system as recited in claim 11, wherein said scalable node controller redirects the interrupt request through the scalability port switch to a different processor.

14. A method for delivering an interrupt request in a multi-node computer system as recited in claim 9, wherein said interrupt request is a broadcast interrupt request.

15. A method for delivering an interrupt request in a multi-node computer system as recited in claim 12, further comprising transmitting an end of interrupt to a correct interrupt controller.

16. A method for delivering an interrupt request in a multi-node computer system as recited in claim 11, wherein the interrupt request is generated by a PCI device.

17. A method for delivering an interrupt request in a multi-node computer system as recited in claim 11, wherein the interrupt request is generated by a processor.

18. A set of instructions residing in a storage medium, said set of instructions capable of being executed by a processor for searching data stored in a mass storage device comprising:
receiving an interrupt request;
determining a scaleable node controller to receive said interrupt request; and
transmitting said interrupt request to said scaleable node controller.

19. A method for delivering an interrupt request in a multi-node computer system as recited in claim 18, further comprising determining a processor to receive the interrupt request.

20. A method for delivering an interrupt request in a multi-node computer system as recited in claim 19, further comprising comparing a priority of the IRQ with a priority of the processor.

21. A method for delivering an interrupt request in a multi-node computer system as recited in claim 20, further comprising interrupting the processor.

22. A method for delivering an interrupt request in a multi-node computer system as recited in claim 20, wherein said scalable node controller redirects the interrupt request through the scalability port switch to a different processor.

23. A method for delivering an interrupt request in a multi-node computer system as recited in claim 18, wherein said interrupt request is a broadcast interrupt request.

24. A method for delivering an interrupt request in a multi-node computer system as recited in claim 21, further comprising transmitting an end of interrupt to a correct interrupt controller.

25. A method for delivering an interrupt request in a multi-node computer system as recited in claim 20, wherein the interrupt request is generated by a PCI device.

26. A method for delivering an interrupt request in a multi-node computer system as recited in claim 20, wherein the interrupt request is generated by a processor.
